(19) United States
(12) Patent Application Publication
(10) Pub. No.: US 2002/0057476 A1
(43) Pub. Date: May 16, 2002

(54) Collective detection method and detection system for wavelength fluctuations in wavelength division multiplexing optical communication system, and wavelength division multiplexing optical transmission apparatus equipped with this detection system

(76) Inventor: Takashi Yamane, Tokyo (JP)

Correspondence Address: McGinn & Gibb, PLLC, Suite 200, 8321 Old Courthouse Road, Vienna, VA, 22182-3817, US

(21) Appl. No.: 09/987,460

(22) Filed: Nov. 14, 2001

(30) Foreign Application Priority Data
Nov. 16, 2000 (JP) 349932/2000

(51) Int. Cl. G02B 6/28; H04J 14/02

(52) U.S. Cl. 359/124; 385/24

(57) ABSTRACT

A wavelength division multiplexing optical transmission apparatus for stabilizing wavelengths by feeding back the output of detection of wavelength fluctuations to the light source is provided with an optical filtering means for branching part of wavelength division multiplexed transmission lights from a plurality of optical transmission means each comprising a semiconductor laser for oscillating signal lights having different wavelengths and modulated with different frequencies and a temperature controller for controlling the temperature of the semiconductor laser, having a plurality of pass bands and transmitting the branched component of the wavelength division multiplexed transmission lights; a means for collectively receiving and photoelectrically converting the lights transmitted by the optical filtering means; and band pass filtering means having as their respective pass bands the photoelectrically converted electrical signals, and each supplying the output of the pass band to the temperature controller for controlling the temperature of the semiconductor laser modulated with the matching frequency. Each of the temperature controllers causes the temperature of the matching one of the semiconductor lasers to keep the outputs of the band pass filtering means at a constant level, and thereby stabilizes each of the wavelengths the wavelength division multiplexed transmission lights contain.

### BACKGROUND OF THE INVENTION

1. Field of the Invention

The present invention relates to a collective detection method and detection system for wavelength fluctuations in a wavelength division multiplexing optical communication system, and a wavelength division multiplexing optical transmission apparatus equipped with this detection system.

2. Description of the Related Prior Art

Along with the rapid growth of the data communication market in recent years, the requirement for expanded transmission capacities is quickly increasing in urgency. To meet this requirement, the wavelength division multiplexing optical communication system (WDM system) was developed, and even for this WDM system attempts have been made to increase the transmission capacity by expanding the range of wavelengths available for use in transmission and increasing the number of wavelengths to be multiplexed. However, as the wavelength range expansion has reached its practicable limit, developmental attempts are now directed to methods to increase the number of available wavelengths by narrowing the intervals between individual wavelengths.

The narrower the wavelength intervals, the greater importance the management of wavelengths (restraint on wavelength fluctuations) takes on. A WDM system using conventional optical transmitters requires for this wavelength management one wavelength detecting element for each such optical transmitter, and therefore each optical transmitter inevitably has to be large, resulting in a large overall size of the transmitting apparatus. In order to prevent the transmitting apparatus from becoming larger, it is desirable to collectively manage a large number of wavelengths.

One of the currently contemplated methods for collectively detecting fluctuations of many wavelengths is the mounting of the apparatus with a light spectrum analyzer or the like. This method, however, boosts the overall cost of the apparatus, because the light spectrum analyzer itself is expensive and the maintenance cost is raised by the need for periodic inspection to secure a satisfactory level of wavelength detection accuracy.

### SUMMARY OF THE INVENTION

An object of the present invention, therefore, is to provide a method and a detection system for collective detection of fluctuations in optical wavelength in a plurality of optical transmitters in a WDM system, and a wavelength division multiplexing optical transmission apparatus using them.

A collective detection method for wavelength fluctuations of signals for use in a wavelength division multiplexing optical communication system according to the invention includes a step of photoelectrically converting wavelength division multiplexed transmission lights consisting of signal lights of a plurality of wavelengths having undergone modulation with mutually different frequencies after causing the lights to be transmitted by optical filters having a plurality of wavelength pass bands, and causing the photoelectrically converted electrical signals to be transmitted by first band pass filters the pass band of each of which is its modulation frequency; and a step of detecting the output level of the pass band of each of the first band pass filters and thereby detecting any fluctuation in each of the wavelengths the wavelength division multiplexed transmission lights contain.

Another collective detection method for wavelength fluctuations further includes a step of branching part of the wavelength division multiplexed transmission lights, photoelectrically converting the branched lights and causing the photoelectrically converted electrical signals to be transmitted by second band pass filters having the same characteristics as the first band pass filters; and a step of dividing, before detecting the output level of the pass band of each of the first band pass filters, the output level of the pass bands of the first band pass filters by the output levels of the pass bands of the respectively matching second band pass filters. The wavelength of each signal light is initially set either in a wavelength band between the pass band and the stop band of the optical filter before the detection of wavelength fluctuations is started or the wavelength band between the pass band and the stop band of the optical filter is so set as to include the wavelength of the signal light before the detection of wavelength fluctuations is started.

A collective detection system for wavelength fluctuations according to the invention is provided with an optical filtering means having a plurality of wavelength pass bands for transmitting wavelength division multiplexed transmission lights consisting of a plurality of signal lights having undergone modulation with mutually different frequencies; a means for collectively receiving and photoelectrically converting the lights transmitted by the optical filtering means; first band pass filtering means each having as its pass band the modulation frequency of each of the photoelectrically converted electrical signals; and a means for detecting the output level of the pass band of each of the band pass filtering means and detecting any fluctuation in each of the wavelengths the wavelength division multiplexed transmission lights contain.

Another collective detection system for wavelength fluctuations is further provided with second band pass filtering means having the same characteristics as the first band pass filtering means for branching part of the wavelength division multiplexed transmission lights, photoelectrically converting the branched lights and transmitting the photoelectrically converted electrical signals; and a means for dividing, before detecting the output level of the pass band of each of the first band pass filtering means, the output levels of the pass bands of the first band pass filtering means by the output levels of the pass bands of the respectively matching second band pass filtering means. The wavelength of each signal light is initially set either in a wavelength band between the pass band and the stop band of the optical filter before the detection of wavelength fluctuations is started or a wavelength band between the pass band and the stop band of the optical filter is so set as to include the wavelength of the signal light before the detection of wavelength fluctuations is started. The band pass filtering means may either be a plurality of band pass filters arranged in parallel, or be provided with means for digitally converting the output signals of the photoelectric conversion means and signal processing means having a digital filtering function.

A wavelength division multiplexing optical transmission apparatus for stabilizing wavelengths by feeding back outputs of detection of wavelength fluctuations according to the present invention is provided with a plurality of optical transmission means each comprising a semiconductor laser for oscillating signal lights having different wavelengths and modulated with different frequencies and a temperature controller for controlling the temperature of the semiconductor laser; a wavelength division multiplexing means for multiplexing a plurality of signal lights into wavelength division multiplexed transmission lights and sending them out; a means for branching part of the wavelength division multiplexed transmission lights; an optical filtering means having a plurality of pass bands and transmitting the branched component of the wavelength division multiplexed transmission lights; a means for collectively receiving and photoelectrically converting the lights transmitted by the optical filtering means; and first band pass filtering means having as their respective pass bands the photoelectrically converted electrical signals, and supplying the outputs of the pass bands to the temperature controller for controlling the temperature of the semiconductor laser modulated with the matching frequency, wherein the temperature controller controls the temperature of the semiconductor laser so as to keep the outputs of the first band pass filtering means at a prescribed level and thereby stabilizes each of the wavelengths the wavelength division multiplexed transmission lights contain.

Another wavelength division multiplexing optical transmission apparatus is further provided with second band pass filtering means, having the same characteristics as the first band pass filtering means, for further branching and photoelectrically converting part of the wavelength division multiplexed transmission lights and transmitting photoelectrically converted electrical signals; and a means for dividing, before supplying the outputs of the pass band of each of the first band pass filtering means to the temperature controller, the output levels of the pass bands of the first band pass filtering means by the output levels of the pass bands of the respectively matching second band pass filtering means. The wavelength of each signal light is initially set either in a wavelength band between the pass band and the stop band of the optical filtering means before the detection of wavelength fluctuations is started or a wavelength band between the pass band and the stop band of the optical filtering means is so set as to include the wavelength of the signal light before the detection of wavelength fluctuations is started. The band pass filtering means may either be a plurality of band pass filters arranged in parallel, or be provided with means for digitally converting the output signals of the photoelectric conversion means and signal processing means having a digital filtering function. The optical filtering means may be either arrayed waveguide grating (AWG) type spectral elements, fiber Bragg grating (FBG) type spectral elements or Fabry-Perot etalon type spectral elements.

A wavelength division multiplexing optical transmission apparatus according to the present invention for stabilizing wavelengths by feeding back the output of wavelength fluctuations to the light source is provided with a plurality of optical transmission means each comprising a semiconductor laser for oscillating signal lights having different wavelengths and modulated with different frequencies and a temperature controller for controlling the temperature of the semiconductor laser; a wavelength division multiplexing means for multiplexing the plurality of signal lights into wavelength division multiplexed transmission lights and sending them out; a means for branching part of the wavelength division multiplexed transmission lights; an optical filtering means having a plurality of pass bands and transmitting the branched component of the wavelength division multiplexed transmission lights; a means for collectively receiving and photoelectrically converting the lights transmitted by the optical filtering means; and first band pass filtering means having as their respective pass bands the photoelectrically converted electrical signals, and each supplying the output of the pass band to the temperature controller for controlling the temperature of the semiconductor laser modulated with the matching frequency, wherein each of the temperature controllers causes the temperature of the matching one of the semiconductor lasers to fluctuate at a low frequency and controls the temperature of the semiconductor laser so as to minimize the low frequency outputs of the first band pass filtering means and thereby stabilizes each of the wavelengths the wavelength division multiplexed transmission lights contain.

Another wavelength division multiplexing optical transmission apparatus is further provided with second band pass filtering means, having the same characteristics as the first band pass filtering means, for further branching and photoelectrically converting part of the wavelength division multiplexed transmission lights and transmitting photoelectrically converted electrical signals; and a means for dividing, before supplying the outputs of the pass band of each of the first band pass filtering means to the temperature controllers, the output levels of the pass bands of the first band pass filtering means by the output levels of the pass bands of the respectively matching ones of the second band pass filtering means. The wavelength of each of signal lights is initially set in the pass band of said optical filtering means before said detection of wavelength fluctuations is started or a wavelength band between the pass band and the stop band of the optical filtering means is so set as to include the wavelength of the signal light before the detection of wavelength fluctuations is started. The band pass filtering means may either be a plurality of band pass filters arranged in parallel, or be provided with means for digitally converting the output signals of the photoelectric conversion means and signal processing means having a digital filtering function. The optical filtering means maybe either arrayed waveguide grating (AWG) type spectral elements, fiber Bragg grating (FBG) type spectral elements or Fabry-Perot etalon type spectral elements.

According to the invention, as multiplexed lights are used for wavelength detection, wavelength fluctuations can be detected with an extremely simple configuration. As the expansion of circuit dimensions accompanying an increase in multiplexing (the number of wavelengths), the size and cost of the whole WDM apparatus can be significantly reduced.

### BRIEF DESCRIPTION OF THE DRAWINGS

The above and other objects, features and advantages of the present invention will become apparent from the following detailed description when taken in conjunction with the accompanying drawings in which:

FIG. 1 illustrates the configuration of a collective detection system for wavelength fluctuations in a wavelength division multiplexing optical communication system, which is a preferred embodiment of the invention;

FIG. 2 illustrates the configuration of an example of optical transmitter in the collective detection system for wavelength fluctuations of FIG. 1;

FIG. 3 illustrates the configuration of an example of wavelength detector in the collective detection system for wavelength fluctuations of FIG. 1;

FIG. 4 shows the relationship between the wavelength pass characteristic of the optical filter in the wavelength detector of FIG. 3 and the initially set oscillation wavelength of the optical transmitter;

FIG. 5 is an aid to description of the wavelength spectra of lights coming incident on the optical filter of FIG. 4;

FIG. 6 is an aid to description of the wavelength spectra of lights transmitted by the optical filter of FIG. 4;

FIG. 7 is an aid to description of the frequency spectra of electrical signals resulting from the photoelectric conversion of lights transmitted by the optical filter of FIG. 4;

FIG. 8 shows the relationship between the wavelength pass characteristic of a different optical filter from that referred to in FIG. 4 in the wavelength detector of FIG. 3 and the initially set oscillation wavelength of the optical transmitter;

FIG. 9 illustrates a wavelength division multiplexing optical transmission apparatus in another preferred embodiment of the present invention;

FIG. 10 illustrates the configuration of an optical transmitter embodying the invention in the wavelength division multiplexing optical transmission apparatus of FIG. 9;

FIG. 11 shows the relationship between the wavelength pass characteristic of a different optical filter in the wavelength division multiplexing optical transmission apparatus of FIG. 9 and the optical transmission wavelength in a different embodiment from that referred to in FIG. 4 and 8 ;

FIG. 12 illustrates the configuration of a wavelength detector which is another embodiment of the invention in the collective detection system for wavelength fluctuations of FIG. 1; and

FIG. 13 illustrates the configuration of a wavelength detector which is still another embodiment of the invention in the collective detection system for wavelength fluctuations of FIG. 1.

### DETAILED DESCRIPTION OF THE PREFERRED EMBODIMENTS

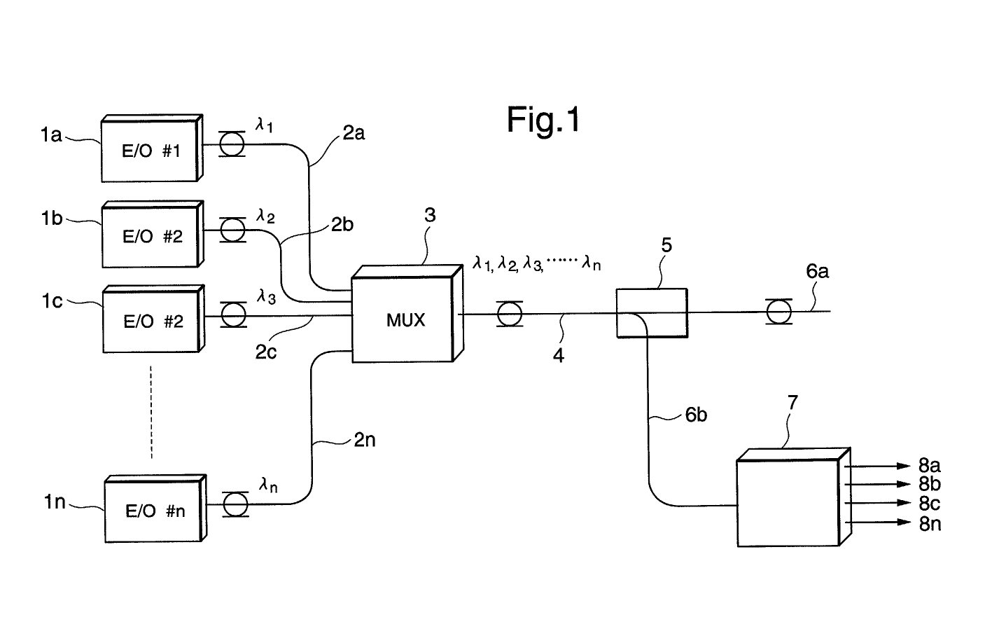

FIG. 1 illustrates the configuration of a collective detection system for wavelength fluctuations, which is a first preferred embodiment of the present invention. This collective detection system for wavelength fluctuations comprises n optical transmitters 1x (x=a, b, c, . . . n) differing in wavelength from one another, an optical multiplexer 3 for multiplexing the output lights of the optical transmitters 1, an optical branching device 5 for branching part of a multiplexed optical output 4, and a wavelength detector 7 for collectively detecting wavelength fluctuations of the branched lights.

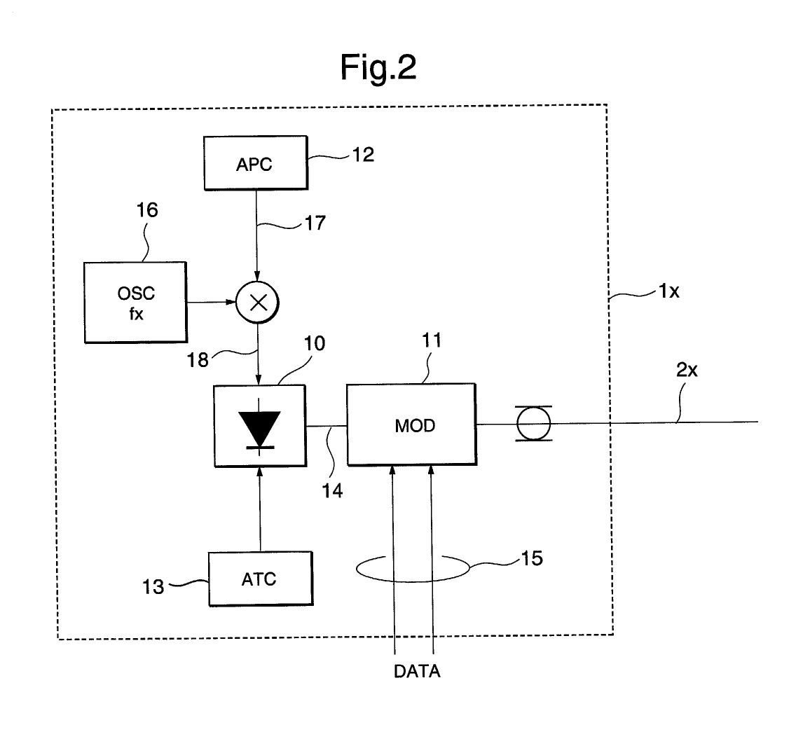

FIG. 2 illustrates the configuration of the optical transmitters 1. Each optical transmitter comprises a continuously oscillating LD module 10, an automatic power control (APC) circuit 12 for controlling the output light power of the LD module 10, an automatic temperature control (ATC) circuit 13 for controlling the LD temperature, an optical modulator 11 for subjecting the continuously oscillating output light 14 of the LD module 10 to optical modulation according to a DATA signal 15 (electrical signal) from outside, and an oscillator 16 for subjecting the output light of the optical transmitter to amplitude modulation. This amplitude modulation of the output light is accomplished with a drive current 18 resulting from superposition of a continuous wave of a frequency fx over the output current 17 of the APC circuit 12. The depth of this modulation is limited to an extent of not affecting the transmission characteristics. The frequency fx is low enough relative to the wavelength intervals between LD modules and the data rate.

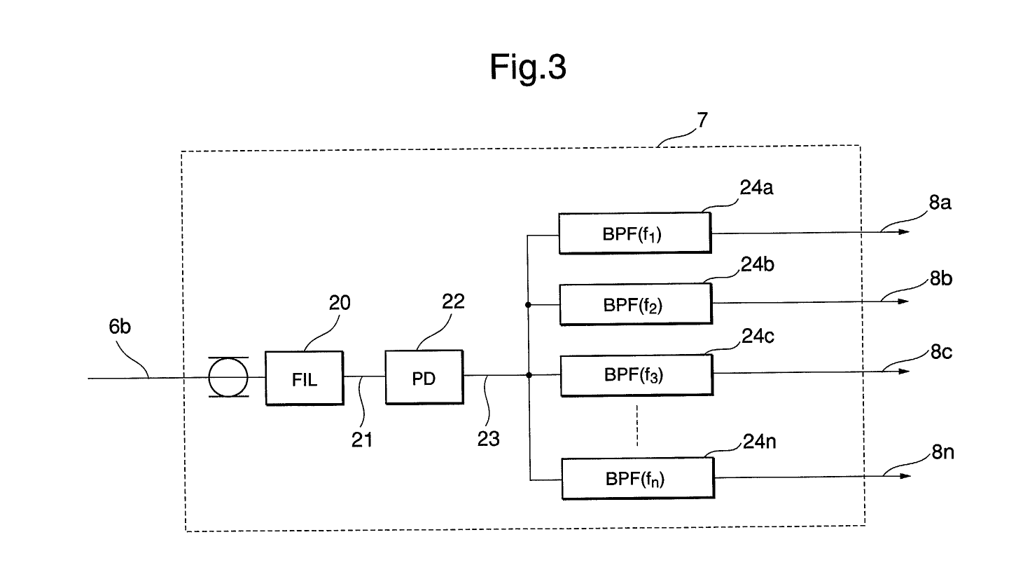

FIG. 3 illustrates the configuration of the wavelength detector 7. The wavelength detector comprises an optical filter20, anphotoelectricconverter22 (e.g. a photodetector, abbreviated to PD) for collectively receiving lights transmitted by the optical filter, and a plurality of electrical band pass filters (BPFs) 24 differing from one another in the center frequency of filtering.

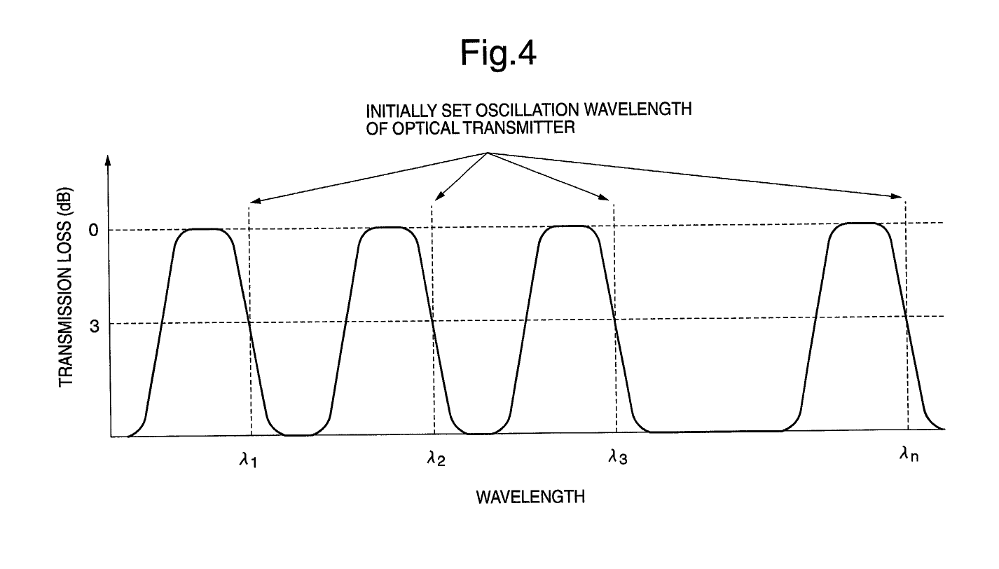

FIG. 4 shows the wavelength characteristic of the optical filter 20. The transmission wavelength has periodicity. The center wavelength of each pass band is so set that, out of two wavelength positions where the loss is 3 dB greater than at the center wavelength, the wavelength position toward the longer wavelength side coincide with the oscillation frequency of the optical transmitter. Or the wavelength of each optical transmitter is so initially set that, out of two wavelength positions where the loss is 3 dB greater than the minimum transmission loss with respect to the wavelength characteristic of the optical filter 20, the wavelength position toward the longer wavelength side coincide with the oscillation frequency of the optical transmitter. What can be used as an optical filter having such a characteristic include spectral elements such as arrayed waveguide gratings (AWG), fiber Bragg gratings (FBG) and Fabry-Perot etalons.

The center frequencies of the band pass filters 24a, 24b, 24c and 24n are set to be respectively identical with amplitude modulation frequencies f1, f2, f3 and fn applied to the output lights 2a, 2b, 2c and 2d of the optical transmitters.

Next will be described the operation of this preferred embodiment.

Referring to FIG. 2, in each of the optical transmitters 1a, 1b, 1c and 1n, the oscillator 16 within the optical transmitter superposes a continuous wave over a bias current 17 applied to the LD module 10, and thereby oscillates the drive current 18 of the LD module. The oscillated drive current 18 amplitude-modulates the output light power 14 emitted from the LD module. The frequency fx for use in amplitude modulation then is set to be frequencies f1, f2, f3 and fn differing for the optical transmitters 1a, 1b, 1c and 1n, respectively. In this way, the optical transmitters 1a, 1b, 1c and 1n supplies optical signals 2a, 2b, 2c and 2n, differently amplitude-modulated with the frequencies f1, f2, f3 and fn. Obviously their wavelengths also differ from one another.

The optical signals 2a, 2b, 2c and 2n supplied by the optical transmitters 1a, 1b, 1c and 1n, respectively, undergo wavelength division multiplexing by the optical multiplexer 3 to generate the multiplexed light 4. A light 6b resulting from partial branching of the multiplexed light 4 by the optical branching device 5 is entered into the optical wavelength detector 7. A light 6a constituting a majority of the multiplexed light 4 is transmitted over a transmission path.

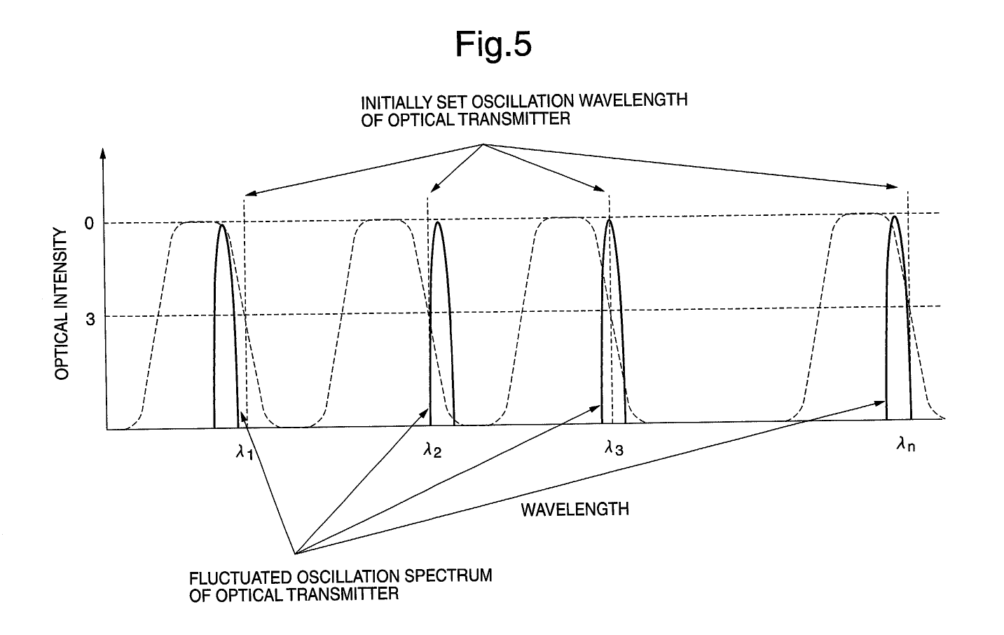

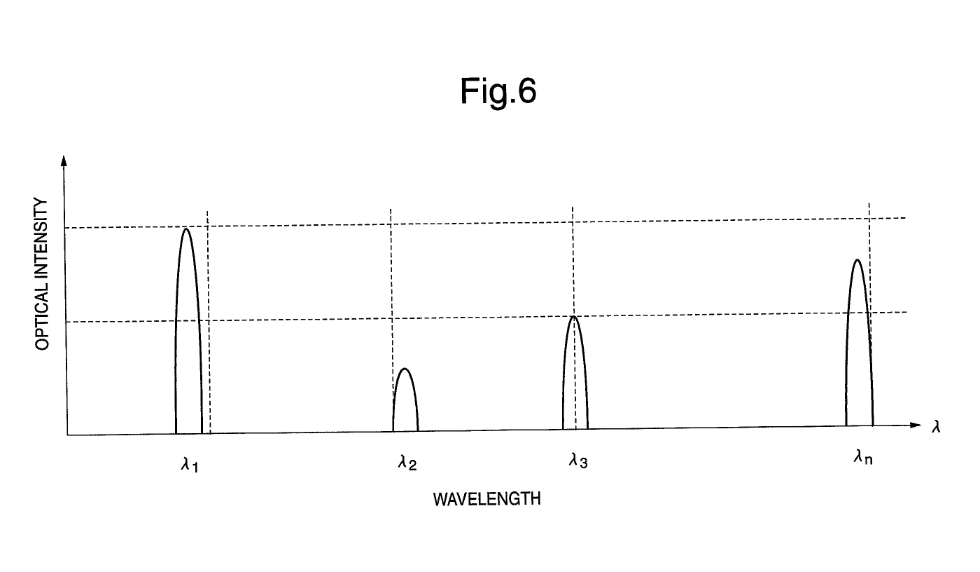

Referring to FIG. 3, the light 6b entered into the optical wavelength detector 7 passes the optical filter 20. As this optical filter 20 has the wavelength characteristic shown in FIG. 4 as described above, the power of a transmitted light 21 will vary if the wavelength of the incident light fluctuates. Thus, supposing that the spectrum of the multiplexed light 4 coming incident on the optical filter 20 varies from the initially set wavelength as shown in FIG. 5 in the spectral intensity distribution of the transmitted light 21 of the filter 20 as shown in FIG. 6, the loss suffered by the optical filter will be smaller than at the time of initial setting because the oscillation wavelength λ1 of the optical transmitter 1a has shifted to a shorter wavelength than at the time of initial setting. Further, as the oscillation wavelength λ2 of the optical transmitter 1b has shifted to a longer wavelength than at the time of initial setting, the transmission loss of the optical filter will be greater than at the time of initial setting. On the other hand, as the oscillation wavelength λ3 of the optical transmitter 1c has remained unchanged from that at the time of initial setting, the loss suffered by the optical filter also remains unchanged. It has to be noted, however, that the multiplexed light is not yet separated into different wavelengths in this state, and it cannot be determined which of the optical transmitters 1a, 1b, 1c and in has fluctuated in wavelength and in which direction, whether toward a longer or shorter wavelength.

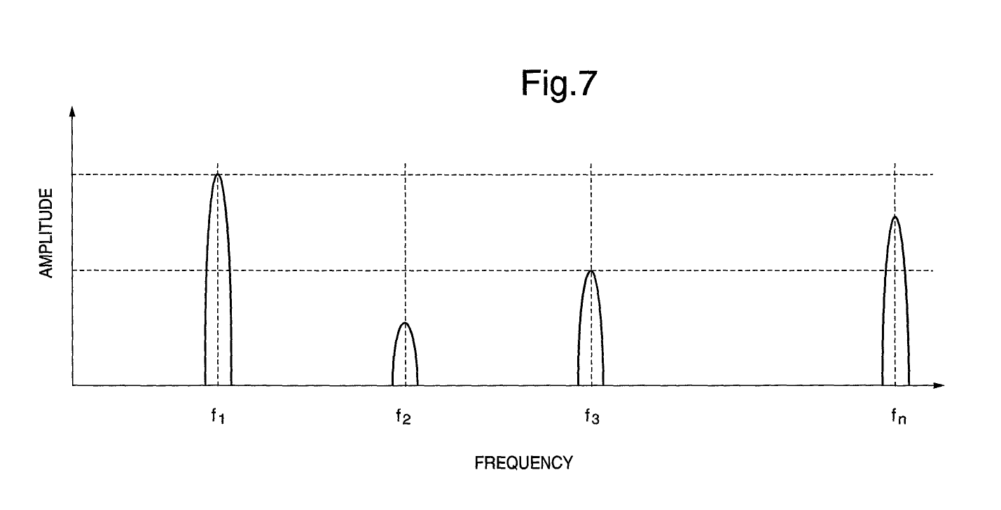

The transmitted light 21 of the optical filter 20 is converted into electrical signal 23 by the photoelectric converter 22 and distributed to the band pass filters 24a, 24b, 24c and 24n. Here, the pass frequencies of the band pass filters 24a, 24b, 24c and 24n are set to the amplitude modulation frequencies f1, f2, f3 and fn, respectively, applied to the optical transmitter outputs 2a, 2b, 2c and 2n. The amplitudes of the outputs 8a, 8b, 8c and 8n of the band pass filters 24a, 24b, 24c and 24n, as shown in FIG. 7, vary with wavelength fluctuations of the optical transmitters 1a, 1b, 1c and 1n, respectively. If the wavelengths of the optical transmitters become shorter than at the time of initial setting, the levels of the signal outputs 8 of these band pass filters rise, or if they become longer, the output levels will drop. Thus, as the amplitude component of the output of each band pass filter varies with a wavelength fluctuation, the fluctuating magnitude and direction of each wavelength can be detected.

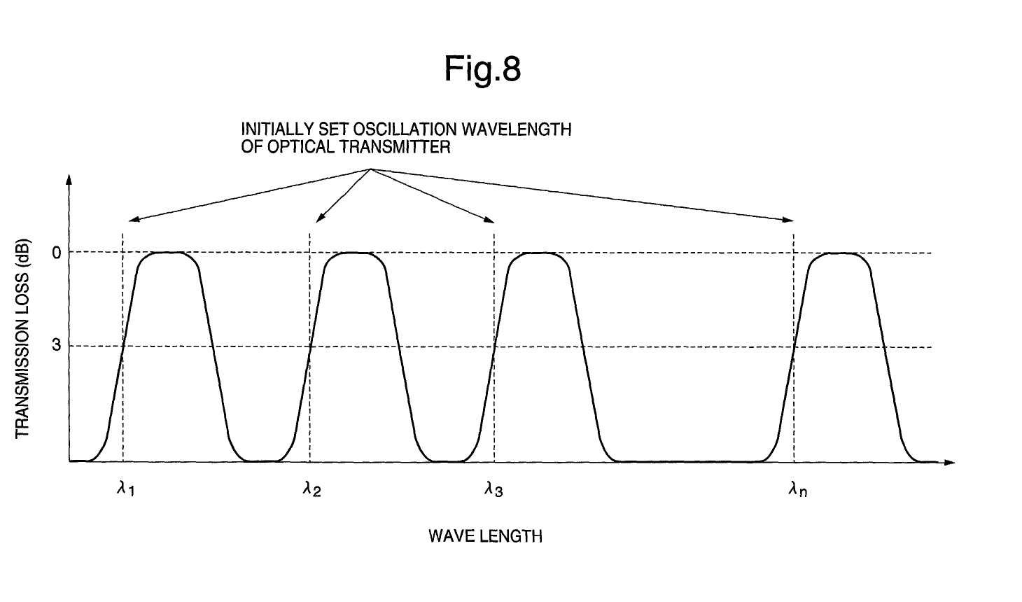

Although in the foregoing description of the preferred embodiment of the invention the relationship between the wavelength characteristics of the optical filter 20 and the emitting wavelength of the optical transmitter at the time of initial setting it is supposed that, out of two wavelength positions where the loss is 3 dB greater than the minimum transmission loss in the pass band of the optical filter, the wavelength position toward the longer wavelength side coincide with the oscillation frequency of the optical transmitter as shown in FIG. 4, the same effect can be achieved if the wavelength position toward the shorter wavelength side coincide with the oscillation wavelength of the optical transmitter as shown in FIG. 8.

Next will be described a wavelength division multiplexing optical transmission apparatus, which is a second preferred embodiment of the present invention. This wavelength division multiplexing optical transmission apparatus utilizes the collective detection system for wavelength fluctuations illustrated in FIG. 1.

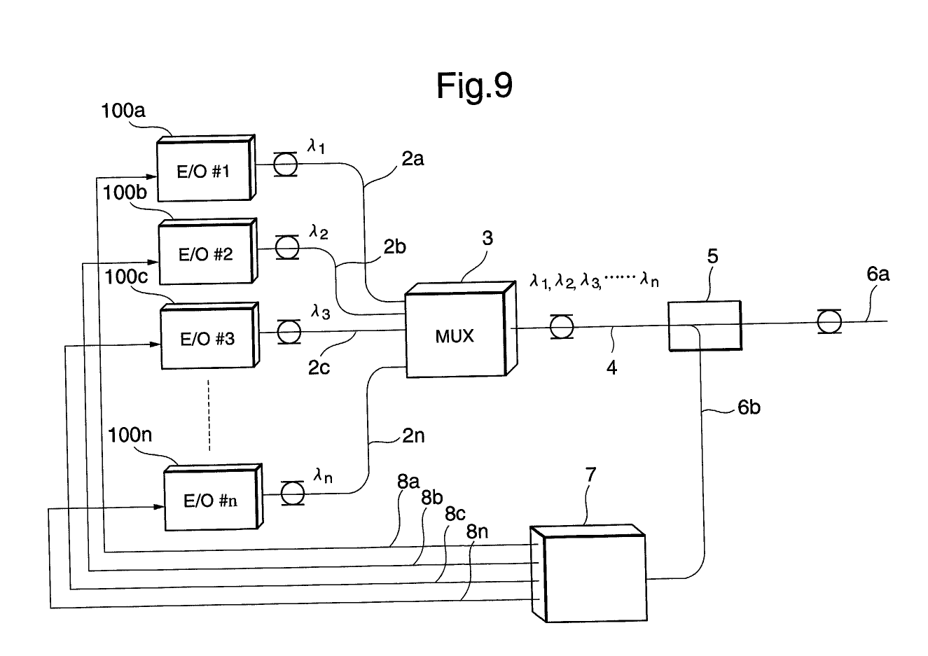

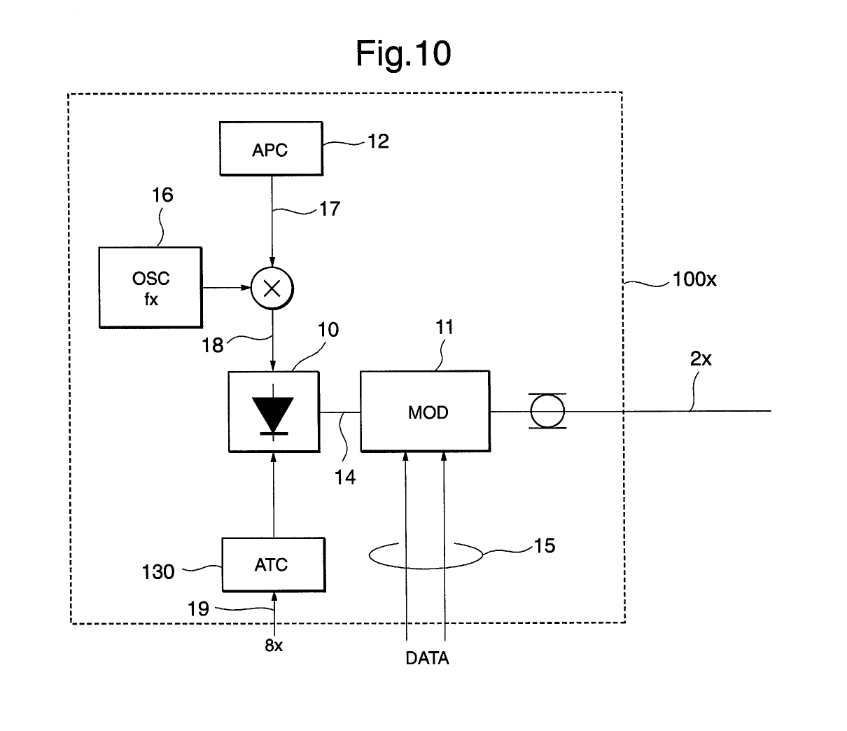

FIG. 9 illustrates the overall system configuration of the wavelength division multiplexing optical transmission apparatus, and FIG. 10, the configuration of each of the optical transmitters constituting the wavelength division multiplexing optical transmission apparatus.

Referring to FIG. 9, in this wavelength division multiplexing optical transmission apparatus, substantially similar in the elements constituting the apparatus to the wavelength detection system of FIG. 1, wiring is so arranged that a variable signal of λx in wavelength detected by the wavelength detector 7 be fed back to a matching optical transmitter 100x. Each of the fed back wavelength variable signals 8x is entered as a signal 19 to an ATC 130 of the optical transmitter 100x shown in FIG. 10. Therefore, the function of the ATC differs between the embodiment shown in FIG. 1 and that shown in FIG. 9. The ATC 130 can keep the oscillation wavelength of the LD module 10 constantly at the prescribed wavelength of the optical filter mentioned above by controlling the temperature of the LD module so as to maintain the signal output 8x of each wavelength always at a prescribed level.

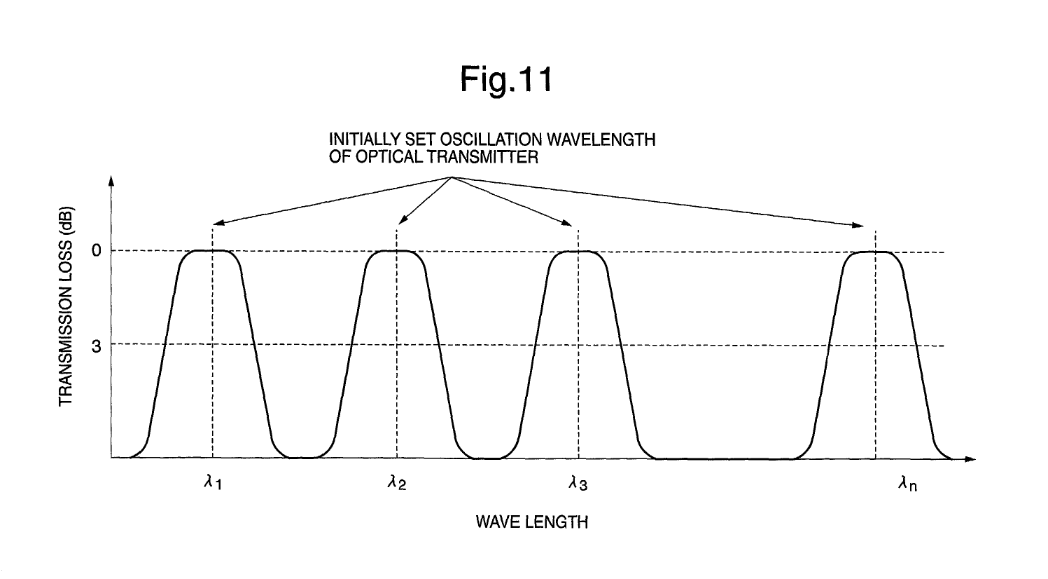

Although in the foregoing description of the wavelength division multiplexing optical transmission apparatus in this embodiment of the invention, the relationship between the wavelength characteristic of the optical filter 20 in the wavelength detector 7 and the emitting wavelength of the optical transmitter at the time of initial setting is set in either one of the two wavelength positions where the loss is 3 dB greater than the minimum transmission loss in the pass band of the optical filter because the wavelength detection system of FIG. 1 is used, it may as well be so set as to make the center wavelength position of the pass band of the optical filter and the oscillation wavelength of the optical transmitter coincide with each other at the time of initial setting as shown in FIG. 11. In this case, the operation to keep the wavelength constant in the wavelength division multiplexing optical transmission apparatus takes place as described below.

The ATC 130 wobbles the temperature of the LD module in a sine wave form at a low frequency. This wobbling of temperature gives rise to a variation in the oscillation wavelength of the LD in a sine wave form. This variation in wavelength also causes the amplitude of the output signal 8x of the wavelength detector of each wavelength to vary. Depending on whether the oscillation wavelength of a given LD module deviates to the pass center wavelength of the optical filter, the phase of the waveform emerging in the output signal 8x of the wavelength detector when the temperature of the LD module is wobbled is reversed. The greater the deviation of the oscillation wavelength of the LD module from the center wavelength of the pass band of the optical filter, the wider the amplitude of the output signal of the wavelength detector. The ATC 130 controls the temperature of the LD module so as to keep the output of the wavelength detector at 0 even though the temperature of the LD module is wobbled. In this way, the ATC 130 can keep the oscillation wavelength of the LD module 10 fixed at the center wavelength of the pass band of the optical filter all the time. This method to keep the oscillation wavelength of the LD module 10 constant is superior in stability to the earlier described second preferred embodiment though slower in the wavelength pulling speed and in the response speed of the feedback system formed of the wavelength detector and the optical transmitter.

Next will be described a third preferred embodiment of the present invention.

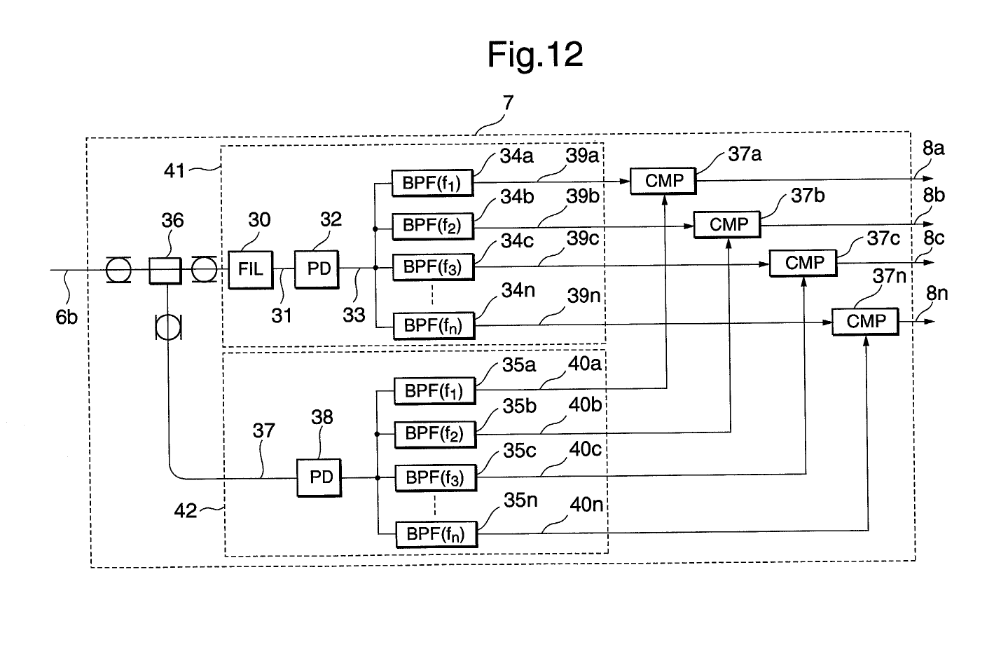

FIG. 12 shows the configuration of a wavelength detector in a different embodiment of the invention. A wavelength detector 71 comprises an optical branching device 36 for branching the input light 6b, a first modulation spectrum extraction unit 41 for performing spectrum extraction of amplitude-modulated signals of one of the lights having gone through branching, a second modulation spectrum extraction unit 42 for performing spectrum extraction of amplitude-modulated signals of the other of the lights having gone through branching, and a plurality of comparators 37 for comparing the electrical output of the first modulation spectrum extraction unit 41 and the second modulation spectrum extraction unit 42 and supplying the results of comparison.

The first modulation spectrum extraction unit 41, having the same configuration as the wavelength detector 7 of FIG. 3, comprises an optical filter 30, a photoelectric converter 22 for collectively receiving lights transmitted by the optical filter, and a plurality of electrical band pass filters 34, differing in the center frequency of the pass band from one another, for filtering photoelectrically converted signals.

The second modulation spectrum extraction unit 42, having the same configuration as the wavelength detector 7 of FIG. 3 except that the optical filter 20 is absent, comprises a photoelectric converter 33 for collectively receiving the other light 32 the lights having gone through branching, and a plurality of electrical band pass filters 35, differing in the center frequency of the pass band from one another, for filtering photoelectrically converted signals.

The optical filter 30 has the same characteristics as the optical filter 20 used in the wavelength detector 7 of FIG. 3. The band pass filters 34 and 35 have the same characteristics as the band pass filters 24 used in the wavelength detector 7 of FIG. 3.

This wavelength detector 71, as its configuration is designed to electrically compare with the comparators 37 the intensity of lights transmitted by the optical filter 30 and that of light not transmitted by the optical filter, can cancel the impacts of fluctuations in the incident optical power. The wavelength detector 7 of FIG. 3 detects with the optical filter 20 fluctuations in the oscillation wavelength of LD modules as converted into fluctuations in transmitted optical power. If only the light of a specific wavelength entered into the wavelength detector 7 drops in power with its wavelength unchanged as a result of the deterioration of the LD modules over time of an increase in the insertion loss of the optical multiplexer 3, the wavelength detector 7 will mistake the drop in power for a fluctuation in wavelength and detect it as such.

The wavelength detector 71 in this embodiment of the invention has a configuration permitting cancellation of the impacts of fluctuations in the incident optical power. Thus, as a light 38 not having passed the filter has no wavelength dependence, electrical signals 40a, 40b, 40c and 40n matching the power of the output lights of optical transmitters 1a, 1b, 1c and 1n multiplexed by the optical multiplexer are supplied. Accordingly, by comparing the electrical signals 40a, 40b, 40c, 40n with the electrical signals 39a, 39b, 39c and 39n having passed the optical filter, the impacts of fluctuations in the incident optical power of the optical transmitters 1 or the optical multiplexer 3 can be cancelled. The comparison is achieved by dividing the electrical signals 39x photoelectrically converted after having passed the optical filter 30 by the electrical signals 40x photoelectrically converted without passing the optical filter.

Next will be described a fourth preferred embodiment of the present invention.

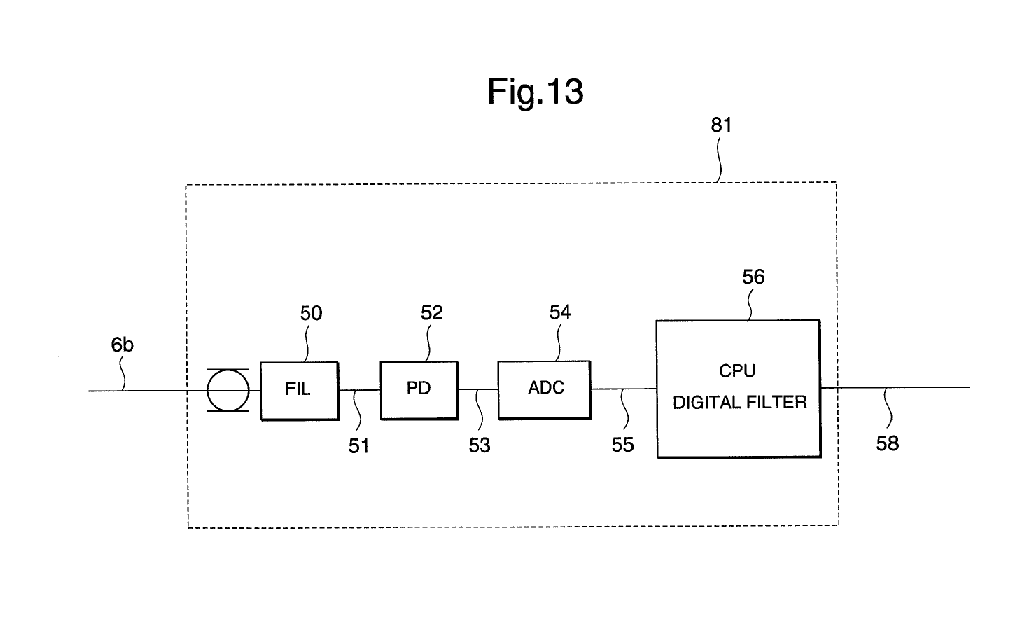

FIG. 13 illustrates the configuration of a wavelength detector 81 different from the wavelength detector 7 used in the first embodiment. In the wavelength detector 81, the plurality of band pass filters 24 constituting the wavelength detector 7 shown in FIG. 3 are replaced by an AD converter 54 and a digital signal processing device (CPU) 56 for digital filtering.

Referring to FIG. 13, the wavelength detector 81 comprises an optical filter 50 whose pass wavelength is the oscillation wavelength of a wavelength-multiplexing optical transmitter, a photoelectric converter 52 for photoelectrically converting lights having passed the optical filter 50, the AD converter 54 for AD converting an output 53 photoelectrically converted by the photoelectric converter 52, and the digital signal processing device (CPU) 56 for digitally processing the signals converted into digital signals 55.

By realizing a digital filter with the digital signal processing device (CPU) 56, it is made possible to take out only desired wavelength components. This method, as it can adapt to any increase in the number of wavelengths by merely altering the firmware of the digital signal processing device (CPU) 56, the circuit configuration and size of the wavelength detector 7 is made independent of the number of wavelengths serving to readily permit system extension.

While the present invention has been described with reference to certain preferred embodiments, it is to be understood that the subject matter encompassed by the present invention is not limited to those specific embodiments. Instead, it is intended to include all such alternatives, modifications, and equivalents as can be included within the spirit and scope of the following claims.

What is claimed is:

1. A collective detection method for wavelength fluctuations of signals for use in a wavelength division multiplexing optical communication system including:
a step of photoelectrically converting wavelength division multiplexed transmission lights consisting of signal lights of a plurality of wavelengths having undergone modulation with mutually different frequencies after causing the lights to be transmitted by optical filters having a plurality of wavelength pass bands, and causing said photoelectrically converted electrical signals to be transmitted by first band pass filters the pass band of each of which is said modulation frequency; and a step of detecting the output level of the pass band of each of said first band pass filters and thereby detecting any fluctuation in each of the wavelengths said wavelength division multiplexed transmission lights contain.

2. The collective detection method for wavelength fluctuations, as claimed in claim 1, further including:
a step of branching part of said wavelength division multiplexed transmission lights, photoelectrically converting the branched lights and causing said photoelectrically converted electrical signals to be transmitted by second band pass filters having the same characteristics as said first band pass filters; and a step of dividing, before detecting the output level of the pass band of each of said first band pass filters, the output level of the pass bands of said first band pass filters by the output levels of the pass bands of the respectively matching ones of said second band pass filters.

3. The collective detection method for wavelength fluctuations, as claimed in claim 1, wherein:
the wavelength of each of said signal lights is initially set in a wavelength band between the pass band and the stop band of said optical filter before said detection of wavelength fluctuations is started.

4. The collective detection method for wavelength fluctuations, as claimed in claim 1, wherein:
the wavelength band between the pass band and the stop band of said optical filter is so set as to include the wavelength of each of said signal lights before said detection of wavelength fluctuations is started.

5. A collective detection system for wavelength fluctuations for use in a wavelength division multiplexing optical communication system is provided with:
an optical filtering means having a plurality of wavelength pass bands for transmitting wavelength division multiplexed transmission lights consisting of a plurality of signal lights having undergone modulation with mutually different frequencies;
a means for collectively receiving and photoelectrically converting the lights transmitted by said optical filtering means;
first band pass filtering means each having as its pass band said modulation frequency of each of said photoelectrically converted electrical signals; and
a means for detecting the output level of the pass band of each of said band pass filtering means and detecting any fluctuation in each of the wavelengths said wavelength division multiplexed transmission lights contain.

6. The collective detection system for wavelength fluctuations, as claimed in claim 5, further provided with:
second band pass filtering means having the same characteristics as said first band pass filtering means for branching part of said wavelength division multiplexed transmission lights, photoelectrically converting the branched lights and transmitting said photoelectrically converted electrical signals; and
a means for dividing, before detecting the output level of the pass band of each of said first band pass filters, the output level of the pass bands of said first band pass filters by the output levels of the pass bands of the respectively matching ones of said second band pass filters.

7. The collective detection system for wavelength fluctuations, as claimed in claim 5, wherein:
the wavelength of each of said signal lights is initially set in a wavelength band between the pass band and the stop band of the optical filtering means before said detection of wavelength fluctuations is started.

8. The collective detection system for wavelength fluctuations, as claimed in claim 5, wherein:
a wavelength band between the pass band and the stop band of said optical filtering means is so set as to include the wavelength of each of said signal lights before said detection of wavelength fluctuations is started.

9. The collective detection system for wavelength fluctuations, as claimed in claim 5, wherein:
said band pass filtering means consists of a plurality of band pass filters arranged in parallel.

10. The collective detection system for wavelength fluctuations, as claimed in claim 5, wherein:
said band pass filtering means are provided with:
a means for digitally converting the output signals of said photoelectric conversion means and a signal processing means having a digital filtering function.

11. A wavelength division multiplexing optical transmission apparatus for stabilizing wavelengths by feeding back outputs of detection of wavelength fluctuations provided with:
a plurality of optical transmission means each comprising a semiconductor laser for oscillating signal lights having different wavelengths and modulated with different frequencies and a temperature controller for controlling the temperature of said semiconductor laser;
a wavelength division multiplexing means for multiplexing said plurality of signal lights into wavelength division multiplexed transmission lights and sending them out;
a means for branching part of said wavelength division multiplexed transmission lights;
an optical filtering means having a plurality of pass bands and transmitting the branched component of said wavelength division multiplexed transmission lights;
a means for collectively receiving and photoelectrically converting the lights transmitted by said optical filtering means; and
first band pass filtering means having as their respective pass bands said photoelectrically converted electrical signals, and each supplying the output of the pass band to said temperature controller for controlling the temperature of said semiconductor laser modulated with the matching frequency, wherein:
each of said temperature controllers controls the temperature of the matching one of said semiconductor lasers so as to keep the outputs of said first band pass filtering means at a prescribed level and thereby stabilizes each of the wavelengths said wavelength division multiplexed transmission lights contain.

12. The wavelength division multiplexing optical transmission apparatus, as claimed in claim 11, further provided with:
second band pass filtering means, having the same characteristics as said first band pass filtering means, for further branching and photoelectrically converting part of said wavelength division multiplexed transmission lights and transmitting photoelectrically converted electrical signals; and
a means for dividing, before supplying the outputs of the pass band of each of said first band pass filtering means to said temperature controllers, the output levels of the pass bands of said first band pass filtering means by the output levels of the pass bands of the respectively matching ones of said second band pass filtering means.

13. The wavelength division multiplexing optical transmission apparatus, as claimed in claim 11, wherein:
the wavelength of each of said signal lights is initially set in a wavelength band between the pass band and the stop band of said optical filtering means before said detection of wavelength fluctuations is started.

14. The wavelength division multiplexing optical transmission apparatus, as claimed in claim 11, wherein:
a wavelength band between the pass band and the stop band of said optical filtering means is so set as to include the wavelength of each of said signal lights before said detection of wavelength fluctuations is started.

15. The wavelength division multiplexing optical transmission apparatus, as claimed in claim 11, wherein:
said band pass filtering means consist of a plurality of electrical band pass filters arranged in parallel.

16. The wavelength division multiplexing optical transmission apparatus, as claimed in claim 11, wherein:
said band pass filtering means are provided with:
means for digitally converting the output signals of said photoelectric conversion means and signal processing means having a digital filtering function.

17. The wavelength division multiplexing optical transmission apparatus, as claimed in claim 11, wherein:
said optical filtering means are arrayed waveguide grating (AWG) type spectral elements.

18. The wavelength division multiplexing optical transmission apparatus, as claimed in claim 11, wherein:
fiber Bragg grating (FBG) type spectral elements.

19. The wavelength division multiplexing optical transmission apparatus, as claimed in claim 11, wherein:
said optical filtering means are Fabry-Perot etalon type spectral elements.

20. A wavelength division multiplexing optical transmission apparatus for stabilizing wavelengths by feeding back outputs of detection of wavelength fluctuations provided with:
a plurality of optical transmission means each comprising a semiconductor laser for oscillating signal lights having different wavelengths and modulated with different frequencies and a temperature controller for controlling the temperature of said semiconductor laser;
a wavelength division multiplexing means for multiplexing said plurality of signal lights into wavelength division multiplexed transmission lights and sending them out;
a means for branching part of said wavelength division multiplexed transmission lights;
an optical filtering means having a plurality of pass bands and transmitting the branched component of said wavelength division multiplexed transmission lights;
a means for collectively receiving and photoelectrically converting the lights transmitted by said optical filtering means; and
first band pass filtering means having as their respective pass bands said photoelectrically converted electrical signals, and each supplying the output of the pass band to said temperature controller for controlling the temperature of said semiconductor laser modulated with the matching frequency, wherein:
each of said temperature controllers causes the temperature of the matching one of said semiconductor lasers to fluctuate at a low frequency and controls the temperature of said semiconductor laser so as to minimize said low frequency outputs of said first band pass filtering means and thereby stabilizes each of the wavelengths said wavelength division multiplexed transmission lights contain.

21. The wavelength division multiplexing optical transmission apparatus, as claimed in claim 20, further provided with:
second band pass filtering means, having the same characteristics as said first band pass filtering means, for further branching and photoelectrically converting part of said wavelength division multiplexed transmission lights and transmitting photoelectrically converted electrical signals; and
a means for dividing, before supplying the outputs of the pass band of each of said first band pass filtering means to said temperature controllers, the output levels of the pass bands of said first band pass filtering means by the output levels of the pass bands of the respectively matching ones of said second band pass filtering means.

22. The wavelength division multiplexing optical transmission apparatus, as claimed in claim 20, wherein:
the wavelength of each of said signal lights is initially set in the pass band of said optical filtering means before said detection of wavelength fluctuations is started.

23. The wavelength division multiplexing optical transmission apparatus, as claimed in claim 20, wherein:
the pass band of said optical filtering means is so set as to include the wavelength of each of said signal lights before said detection of wavelength fluctuations is started.

24. The wavelength division multiplexing optical transmission apparatus, as claimed in claim 20, wherein:
said band pass filtering means consist of a plurality of electrical band pass filters arranged in parallel.

25. The wavelength division multiplexing optical transmission apparatus, as claimed in claim 20, wherein:
said band pass filtering means are provided with:
means for digitally converting the output signals of said photoelectric conversion means and signal processing means having a digital filtering function.

26. The wavelength division multiplexing optical transmission apparatus, as claimed in claim 20, wherein:
said optical filtering means are arrayed waveguide grating (AWG) type spectral elements.

27. The wavelength division multiplexing optical transmission apparatus, as claimed in claim 20, wherein:
fiber Bragg grating (FBG) type spectral elements.

28. The wavelength division multiplexing optical transmission apparatus, as claimed in claim 20, wherein:
said optical filtering means are Fabry-Perot etalon type spectral elements.
